(19) United States
(12) Patent Application Publication
(10) Pub. No.: US 2023/0168469 A1
(43) Pub. Date: Jun. 1, 2023

(54) OPTICAL APPARATUS

(71) Applicant: SONY GROUP CORPORATION, TOKYO (JP)

(72) Inventor: HIDEAKI OKANO, TOKYO (JP)

(21) Appl. No.: 17/920,004

(22) PCT Filed: Apr. 16, 2021
(86) PCT No.: PCT/JP2021/015662

§ 371 Date: Oct. 19, 2022

(30) Foreign Application Priority Data
Apr. 30, 2020 (JP) 2020-080502

(51) Int. Cl. G02B 13/00; G02B 9/12

(52) U.S. Cl. CPC G02B 13/0035; G02B 9/12

(57) ABSTRACT

The present technology relates to an optical apparatus capable of achieving reduction in size and height and improvement in high efficiency of the optical apparatus.

An optical apparatus includes a lens optical system disposed between an object and an optical element, in which the lens optical system includes, in order from a side of the object, a first lens group having negative refractive power and a second lens group having positive refractive power, the first lens group includes a first lens having negative refractive power, the second lens group includes a second lens having positive refractive power and a third lens having positive refractive power, the lens optical system has positive refractive power as a whole, and in a case where a light beam is incident from the side of the object, when a ratio of a light beam incident on a peripheral edge of the optical element to a light beam passing through a center of a lens system including the first lens to the third lens is RI, and an angle of a principal light beam incident on an outermost peripheral edge of the optical element is A−IH, RI×A−IH×0.01>2 is satisfied. The present technology can be applied to, for example, a system that detects a distance to a subject.

### TECHNICAL FIELD

The present technology relates to an optical apparatus, and particularly, to an optical apparatus capable of achieving reduction in size and height and improvement in efficiency.

### BACKGROUND ART

In recent years, an imaging apparatus such as a camera-equipped mobile phone or a digital still camera using an imaging element such as a charge coupled device (CCD), a complementary metal oxide semiconductor (CMOS) image sensor, and the like is required to be further reduced in size and height and improved in efficiency. Therefore, a lens optical system mounted on an imaging apparatus is also required to be reduced in size and height. In addition, there is a demand for a highly efficient lens optical system capable of increasing a peripheral light amount ratio and collecting light beams more efficiently in order to suppress a decrease in the peripheral light amount ratio which tends to occur due to height reduction and reduce a burden on image processing in a subsequent stage.

Furthermore, a lens optical system having a large aperture and a small f-number and being bright is required in order to increase a shutter speed and secure an amount of light incident on the lens optical system while suppressing deterioration of image quality due to noise in dark place imaging.

On the other hand, in order to reduce the size and height and improve the efficiency, for example, a lens optical system of a configuration with three or more lenses is used (see, for example, Patent Document 1.).

The lens optical system disclosed in Patent Document 1 has a three-lens configuration and f-number of about 2.2. Further, a wide angle of view from 110 degrees to 166 degrees is secured. Furthermore, astigmatism is well corrected. It is therefore presumed that the lens optical system disclosed in Patent Document 1 exhibits good performance.

### CITATION LIST

### Patent Document

Patent Document 1: Japanese Patent Application Laid-Open No. 2017-116795

### SUMMARY OF THE INVENTION

### Problems to be Solved by the Invention

However, in the lens optical system disclosed in Patent Document 1, in a case where a light beam is taken in from a side of an object, an angle at which the light beam emitted from a lens final surface is incident on the imaging element increases. It is therefore estimated that a difference between an amount of light beam passing through a center portion of the lens optical system and an amount of light beam passing through a peripheral portion increases, and a peripheral light amount drops.

The present technology has been made in view of such a situation, and an object of the present technology is to achieve reduction in size and height and improvement in efficiency of an optical apparatus.

### Solutions to Problems

An optical apparatus according to one aspect of the present technology includes a lens optical system disposed between an object and an optical element, in which the lens optical system includes, in order from a side of the object, a first lens group having negative refractive power and a second lens group having positive refractive power, the first lens group includes a first lens having negative refractive power, the second lens group includes a second lens having positive refractive power and a third lens having positive refractive power, the lens optical system has positive refractive power as a whole, and in a case where a light beam is incident from the side of the object, when a ratio of a light beam incident on a peripheral edge of the optical element to a light beam passing through a center of a lens system including the first lens to the third lens is RI, and an angle of a principal light beam incident on an outermost peripheral edge of the optical element is A−IH, RI×A−IH×0.01>2 is satisfied.

In one aspect of the present technology, in a case where a light beam is incident from the side of the object, when a ratio of the light beam incident on the peripheral edge of the optical element to the light beam passing through the center of the lens system including the first to third lenses is RI, and an angle of the principal light beam incident on the outermost peripheral edge of the optical element is A−IH, RI×A−IH×0.01>2 is satisfied.

### BRIEF DESCRIPTION OF DRAWINGS

FIG. 1 is a diagram depicting a first configuration example of an optical apparatus to which the present technology is applied.

FIG. 2 is a diagram for describing parameters of a lens optical system.

FIG. 3 is a diagram depicting characteristic data and lens data of a first configuration example of the lens optical system.

FIG. 4 is a diagram depicting aspherical data of the first configuration example of the lens optical system.

FIG. 5 is an aberration diagram of the first configuration example of the lens optical system.

FIG. 6 is a diagram depicting a second configuration example of the optical apparatus to which the present technology is applied.

FIG. 7 is a diagram depicting characteristic data and lens data of the second configuration example of the lens optical system.

FIG. 8 is a diagram depicting aspherical data of the second configuration example of the lens optical system.

FIG. 9 is an aberration diagram of the second configuration example of the lens optical system.

FIG. 10 is a diagram depicting a third configuration example of the optical apparatus to which the present technology is applied.

FIG. 11 is a diagram depicting characteristic data and lens data of the third configuration example of the lens optical system.

FIG. 12 is a diagram depicting aspherical data of the third configuration example of the lens optical system.

FIG. 13 is an aberration diagram of the third configuration example of the lens optical system.

FIG. 14 is a diagram depicting a fourth configuration example of the optical apparatus to which the present technology is applied.

FIG. 15 is a diagram depicting characteristic data and lens data of the fourth configuration example of the lens optical system.

FIG. 16 is a diagram depicting aspherical data of the fourth configuration example of the lens optical system.

FIG. 17 is an aberration diagram of the fourth configuration example of the lens optical system.

FIG. 18 is a diagram depicting a fifth configuration example of the optical apparatus to which the present technology is applied.

FIG. 19 is a diagram depicting characteristic data and lens data of the fifth configuration example of the lens optical system.

FIG. 20 is a diagram depicting aspherical data of the fifth configuration example of the lens optical system.

FIG. 21 is an aberration diagram of the fifth configuration example of the lens optical system.

FIG. 22 is a diagram depicting a sixth configuration example of the optical apparatus to which the present technology is applied.

FIG. 23 is a diagram depicting characteristic data and lens data of the sixth configuration example of the lens optical system.

FIG. 24 is a diagram depicting aspherical data of the sixth configuration example of the lens optical system.

FIG. 25 is an aberration diagram of the sixth configuration example of the lens optical system.

FIG. 26 is a diagram depicting a seventh configuration example of the optical apparatus to which the present technology is applied.

FIG. 27 is a diagram depicting characteristic data and lens data of the seventh configuration example of the lens optical system.

FIG. 28 is a diagram depicting aspherical data of the seventh configuration example of the lens optical system.

FIG. 29 is an aberration diagram of the seventh configuration example of the lens optical system.

FIG. 30 is a diagram depicting an eighth configuration example of the optical apparatus to which the present technology is applied.

FIG. 31 is a diagram depicting characteristic data and lens data of the eighth configuration example of the lens optical system.

FIG. 32 is a diagram depicting aspherical data of the eighth configuration example of the lens optical system.

FIG. 33 is an aberration diagram of the eighth configuration example of the lens optical system.

FIG. 34 is a diagram depicting a ninth configuration example of the optical apparatus to which the present technology is applied.

FIG. 35 is a diagram depicting characteristic data and lens data of the ninth configuration example of the lens optical system.

FIG. 36 is a diagram depicting aspherical data of the ninth configuration example of the lens optical system.

FIG. 37 is an aberration diagram of the ninth configuration example of the lens optical system.

FIG. 38 is a diagram depicting a tenth configuration example of the optical apparatus to which the present technology is applied.

FIG. 39 is a diagram depicting characteristic data and lens data of the tenth configuration example of the lens optical system.

FIG. 40 is a diagram depicting aspherical data of the tenth configuration example of the lens optical system.

FIG. 41 is an aberration diagram of the tenth configuration example of the lens optical system.

FIG. 42 is a diagram depicting an eleventh configuration example of the optical apparatus to which the present technology is applied.

FIG. 43 is a diagram depicting characteristic data and lens data of the eleventh configuration example of the lens optical system.

FIG. 44 is a diagram depicting aspherical data of the eleventh configuration example of the lens optical system.

FIG. 45 is an aberration diagram of the eleventh configuration example of the lens optical system.

FIG. 46 is a diagram depicting specific examples of parameters necessary for calculating a value of a conditional expression of each configuration example of the lens optical system.

FIG. 47 is a diagram depicting specific examples of a value of a conditional expression of each configuration example of the lens optical system.

FIG. 48 is a block diagram depicting an example of schematic configuration of a vehicle control system.

FIG. 49 is a diagram of assistance in explaining an example of installation positions of an outside-vehicle information detecting section and an imaging section.

### MODE FOR CARRYING OUT THE INVENTION

Hereinafter, an embodiment for implementing the present technology (hereinafter referred to as embodiment) will be described with reference to accompanying drawings. Note that, in the present specification and the drawings, components having substantially the same functional configuration are denoted by the same reference signs, and redundant description is omitted. The description will be made in the following order.

1. Embodiment

2. Application example

3. Others

### 1. Embodiment

First, an embodiment of an optical apparatus to which the present technology is applied will be described.

### First Configuration Example

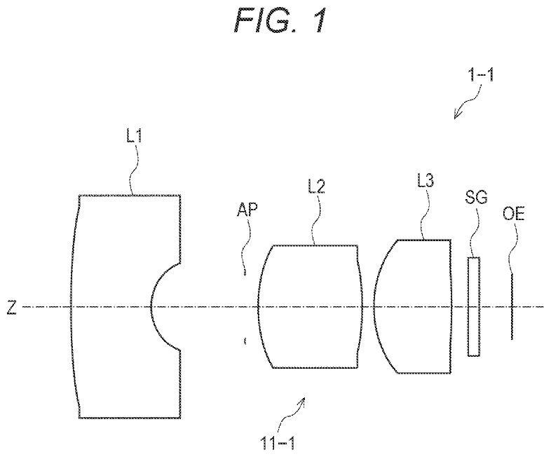

First, a first configuration example of an optical apparatus to which the present technology is applied will be described with reference to FIGS. 1 to 5.

FIG. 1 is a diagram depicting a configuration example of an optical apparatus 1-1 to which the present technology is applied.

The optical apparatus 1-1 includes an optical element OE and a lens optical system 11-1.

The optical element OE includes a light receiving element or a light emitting element. The light receiving element includes, for example, an optical element that converts a light beam received by an image sensor, a photodiode, and the like into an electric signal. The light emitting element includes, for example, an optical element that emits a light beam such as a semiconductor laser (LD) and the like.

The lens optical system 11-1 is disposed between an object and the optical element OE. In a case where the optical element OE is a light receiving element, the lens optical system 11-1 functions as a light receiving optical system for collecting a light beam incident from a side of the object and guiding the light beam to the optical element OE. In a case where the optical element OE is a light emitting element, the lens optical system 11-1 functions as a light emitting optical system for collecting a light beam emitted from the optical element OE and guiding the light beam to the side of the object.

Note that ranges through which light beams pass are similar and directions of the light beams are opposite to each other in a case where the lens optical system 11-1 functions as a light receiving optical system and in a case where the lens optical system functions as a light emitting optical system.

In the lens optical system 11-1, the first lens L1, a diaphragm AP, a second lens L2, a third lens L3, and a sealing glass SG are disposed in order from the side of the object toward the optical element OE. An optical axis or a center of each optical element of the lens optical system 11-1 and the optical element OE coincides with an optical axis Z indicated by a one-dot chain line.

The sealing glass SG can have a function of protecting the optical element OE, a filter function such as an infrared cut filter and a band pass filter, an antireflection function, and the like. Note that the sealing glass SG may be omitted.

Next, design conditions of the lens optical system 11-1 will be described.

Note that, hereinafter, each surface of the first lens L1 to the third lens L3 are represented by Si (i=1 to 6) in order from the side of the object. That is, a surface of the first lens L1 on the side of the object is S1, and a surface of the first lens L1 on the side of the optical element OE is S2. A surface of the second lens L2 on the side of the object is S3, and a surface of the second lens L2 on the side of the optical element OE is S4. A surface of the third lens L3 on the side of the object is S5, and a surface of the third lens L3 on the side of the optical element OE is S6. Further, hereinafter, a curvature radius (mm) of the surface Si of each lens is represented by Ri.

Furthermore, hereinafter, a lens group including the lens L1 on the side of the object of the diaphragm AP is referred to as a first lens group or a front group. In addition, hereinafter, a lens group including the lens L2 and the lens L3 on the side of the optical element OE from the diaphragm AP will be referred to as a second lens group or a rear group.

The lens optical system 11-1 satisfies Conditions 1 and 2 as described later. In addition, the lens optical system 11-1 satisfies at least one of Conditions 3 to 9 as described later and preferably two or more of Conditions 3 to 9, and therefore can achieve a lens optical system that has good condensing performance and optical performance and is reduced in size and height.

(Condition 1)

The lens L1 has negative refractive power. Therefore, the first lens group (front group) including the lens L1 has negative refractive power.

The lens L2 and lens L3 have positive refractive power. Thus, the second lens group (rear group) including the lens L2 and the lens L3 has positive refractive power.

The lens optical system 11-1 as a whole has positive refractive power.

Therefore, in a case where the optical element OE is a light receiving element, an angle of view becomes wide, and a light beam from the side of the object can be efficiently condensed in a wide range and guided to the optical element OE.

In a case where the optical element OE is a light emitting element, the light emitted from the optical element OE is efficiently collected and can be emitted to the side of the object in a wide range.

Furthermore, in addition to good condensing performance and optical performance, a shorter overall optical length can be achieved, and needs for reduction in size and height can be met.

(Condition 2)

Condition 2 is represented by the following conditional expression (1).

RI×A−IH×0.01>2 (1)

In a case where a light beam is incident from the side of the object, RI represents a ratio (hereinafter, referred to as peripheral light amount ratio) of a light beam incident on an outermost peripheral edge of the optical element OE to a light beam passing through a center of a lens system including the first lens L1 to the third lens L3.

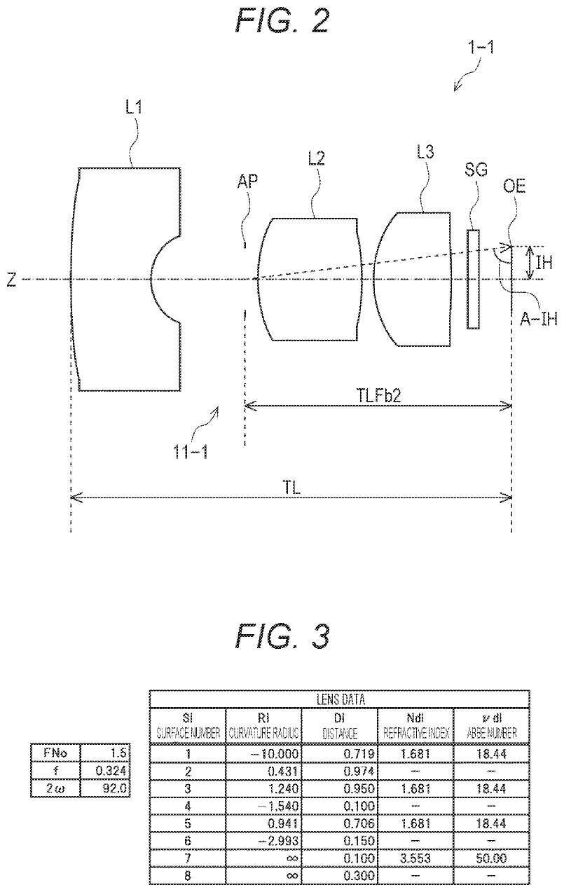

In a case where a light beam is incident from the side of the object, A−IH represents an angle (degree) of a principal light beam incident on the outermost peripheral edge of the optical element OE as illustrated in FIG. 2. Hereinafter, the angle A−IH is referred to as a light beam incident angle.

In a case where the optical element OE is a light receiving element, the conditional expression (1) represents a condition regarding a ratio between a ratio (that is, the peripheral light amount ratio) of a light beam incident on the outermost peripheral edge to a light beam incident on a center portion of the optical element OE and a maximum angle of a light beam incident on the optical element OE. When the conditional expression (1) is satisfied, the angle of the light beam incident on the optical element OE is suppressed. Thus, the light beam is efficiently guided to the optical element OE, and the light condensing performance is improved.

In a case where the optical element OE is a light receiving element, a light beam emitted from the optical element OE is efficiently collected in the lens optical system 11-1 and emitted to the object, and optical performance is improved.

(Condition 3)

The first lens L1 has a concave surface facing the side of the object. That is, the curvature radius R1 of the surface S1 of the first lens L1 on the side of the object satisfies the following conditional expression (2).

R1<0 (2)

Specifically, a central portion of the surface S1 of the first lens L1 has a concave shape (concave lens shape), and a peripheral edge has a convex shape (convex lens shape).

Therefore, in a case where the optical element OE is a light receiving element, the first lens L1 can collect light widely. As a result, the light beam from the side of the object can be efficiently collected up to the peripheral edge of the optical element OE, and shading characteristics are improved.

In a case where the optical element OE is a light emitting element, the light beam emitted from the optical element OE can be efficiently collected up to the peripheral edge of the optical element OE and emitted to the side of the object widely.

(Condition 4)

The third lens L3 has a convex surface facing the side of the object. That is, the curvature radius R5 of the surface S5 of the third lens on the side of the object satisfies the following conditional expression (3).

R5>0 (3)

Thus, in a case where the optical element OE is a light receiving element, the surface S5 of the third lens L3 has a concave lens shape, and thus the light beams collected by the first lens L1 can be collected and incident on the optical element OE with substantially parallel light. Therefore, efficiency is significantly improved, and the ratio of the light beam incident on the peripheral edge of the optical element OE to the light beam incident on the center of the optical element OE is improved.

In a case where the optical element OE is a light emitting element, the light beam emitted from the optical element OE is efficiently collected up to the peripheral edge of the optical element OE and can be emitted to the side of the object.

(Condition 5)

Condition 5 is represented by the following conditional expression (4).

|f/(fa1×fa2)|<2 (4)

Here, f represents a focal length of the lens system as a whole (hereinafter referred to as a total lens system focal length). fa1 represents a focal length of the first lens group (hereinafter referred to as a first lens group focal length). fa2 represents a focal length of the second lens group (hereinafter referred to as a second lens group focal length).

The conditional expression (4) indicates a condition regarding appropriate power distribution between the first lens group and the second lens group with respect to power of the lens system as a whole. An absolute value is used in the conditional expression (4) because the first lens group has negative power. When the value of the conditional expression (4) exceeds an upper limit, the power of the first lens group becomes excessively small as compared with the power of the lens system as a whole and the power of the second lens group, and it becomes difficult to widen the angle of view (viewing angle) or an emission angle of the light beam.

Note that, in consideration of securing the angle of view or the emission angle of the light beam, it is more desirable to satisfy the following conditional expression (4)′.

|f/(fa1×fa2)|<1.6 (4)′

(Condition 6)

Condition 6 is represented by the following conditional expression (5).

(IH/TL)×FOV<25 (5)

As illustrated in FIG. 2, IH represents a magnitude in a direction perpendicular to the optical axis Z of the light beam incident on the optical element OE (hereinafter referred to as a light beam height). For example, in a case where the optical element OE is an imaging element, the light beam height IH represents a maximum image height.

As illustrated in FIG. 2, TL represents a length of the lens optical system 11-1 as a whole (hereinafter referred to as an optical total length). That is, the optical total length TL represents a length from the surface S1 of the first lens L1 on the side of the object to the surface of the optical element OE on the side of the object.

FOV represents an angle of view of the lens optical system 11-1 and corresponds to an angle 2ω of view on both sides.

The conditional expression (5) indicates a relationship between an angle of view (a capturing angle on the side of the object) of the lens optical system 11-1, a size of the optical element OE, a range of an effective image circle through which the light beam passes, and a total length of the lens optical system 11-1. When a value of the conditional expression (5) exceeds an upper limit, the total length of the lens optical system 11-1 becomes excessively long for the range of the angle of view and the effective image circle through which the light beam passes. Therefore, it becomes easy to secure necessary optical performance in a state where the angle of view is maintained, but the lens optical system 11-1 becomes large.

In view of the above, it is more desirable that the following conditional expression (5)′ is satisfied.

(IH/TL)×FOV<20 (5)′

(Condition 7)

Condition 7 is represented by the following conditional expression (6).

2<TLFb2/IH<12 (6)

Here, as illustrated in FIG. 2, TLFb2 represents a length of the lens optical system 11-1 behind the diaphragm AP (hereinafter referred to as a diaphragm-optical element length). That is, the diaphragm-optical element length TLFb2 represents a length from the diaphragm AP to the surface of the optical element OE on the side of the object.

The conditional expression (6) indicates a relationship between the angle of view (a capturing angle on the side of the object) of the lens optical system 11-1, a distance between the first lens L1 and the second lens L2, and the total length of the lens optical system 11-1. When a value of the conditional expression (6) exceeds an upper limit, the total length of the lens optical system 11-1 becomes excessively short for a relationship between the angle of view and the length from the first lens L1 to the second lens L2, and it becomes difficult to ensure necessary optical performance in a state where the angle of view is maintained. When a value of the conditional expression (6) falls below a lower limit, the total length of the lens optical system 11-1 becomes excessively long for the relationship between the angle of view and the length from the first lens L1 to the second lens L2, but the lens optical system 11-1 becomes large.

In view of the above, it is more desirable that the following conditional expression (6)′ is satisfied.

3<TLFb2/IH<10 (6)′

(Condition 8)

Condition 8 is represented by the following conditional expression (7).

0.5<(R1−R2)/(R1+R2)<10.0 (7)

The conditional expression (7) represents a relationship between the curvature radius R1 of the surface S1 of the first lens L1 on the side of the object and the curvature radius R2 of the surface S2 on the side of the optical element OE. When the value of the conditional expression (7) exceeds an upper limit, the curvature radius R2 of the surface S2 on the side of the optical element OE becomes excessively large for the curvature radius R1 of the surface S1 on the side of the object, and it becomes difficult to collect or emit a light beam at a wide angle. On the other hand, when the value of the conditional expression (7) falls below a lower limit, the curvature radius R1 of the surface S1 on the side of the object becomes excessively large for the curvature radius R2 of the surface S2 on the side of the optical element OE, and it becomes difficult to efficiently collect the light beam reaching the peripheral edge of the first lens L1.

(Condition 9)

Condition 9 is represented by the following conditional expression (8).

−2.0<(R3+R4)/(R3−R4)<2.0 (8)

The conditional expression (8) represents a relationship between the curvature radius R3 of the surface S3 of the second lens L2 on the side of the object and the curvature radius R4 of the surface S4 on the side of the optical element OE. When a value of the conditional expression (8) falls within this range, the light beam condensed by the first lens L1 can be efficiently guided to the optical element OE, and a spherical aberration generated by the first lens L1 can be satisfactorily corrected. It is therefore possible to guide the light beam from the side of the object to the optical element OE in a state of being satisfactorily corrected.

FIG. 3 illustrates specific characteristic data of the lens optical system 11-1 and lens data of the first lens L1 to the third lens L3.

In FIG. 3, FNo represents f-number of the lens optical system 11-1, f represents the total lens system focal length (mm), and 2ω represents a total angle of view (degree) (=angle of view FOV) of a diagonal of the lens optical system 11-1.

Furthermore, as described above, Si represents the surface of the i-th lens counted from the side of the object to the side of the optical element OE, and Ri represents the curvature radius of the i-th surface Si. Di represents a distance on the optical axis between the surface S1 of the i-th lens and the surface S (i+1) of the (i+1)th lens, Ndi represents a refractive index at d-line (wavelength 587.6 nm) of the lens starting from the surface S1 of the i-th lens, and νdi represents Abbe number at d-line of the lens starting from the surface Si of the i-th lens.

Further, an aspherical shape of the surface Si of each lens of the lens optical system 11-1 is represented by the following Expression (9).

$$\begin{matrix}[ Math . 1 ] & \\ Z = \frac{{Y}^{2} / R}{1 + \sqrt{1 - ( 1 + K ) {( Y / R )}^{2}}} + \sum Ai \cdot {Y}^{i} & ( 9 )\end{matrix}$$

In Expression (9), Z represents a depth of an aspherical surface, and Y represents a height from the optical axis (position in a direction perpendicular to the optical axis). Furthermore, K represents a conic coefficient, and Ai represents an aspheric coefficient of the i-th order (i is an integer of three or more). R represents a curvature radius.

Note that the meaning of each symbol is similar in other configuration examples as described later.

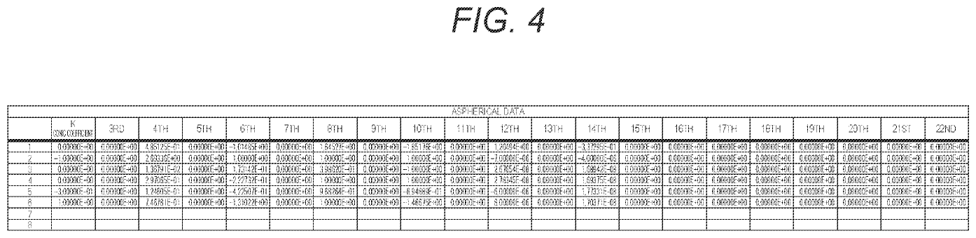

FIG. 4 illustrates values of a conic coefficient K of Expression (9) for specifying the aspheric shape of the surface Si of each lens of the lens optical system 11-1 and an aspheric coefficient Ai of the i-th order (i is an integer of three or more).

Note that, in the value of the aspheric coefficient Ai, a numerical value including a symbol “E” is an expression by an exponential function with a base of 10, and for example, “1.0E−05” indicates “1.0×10⁻⁵”.

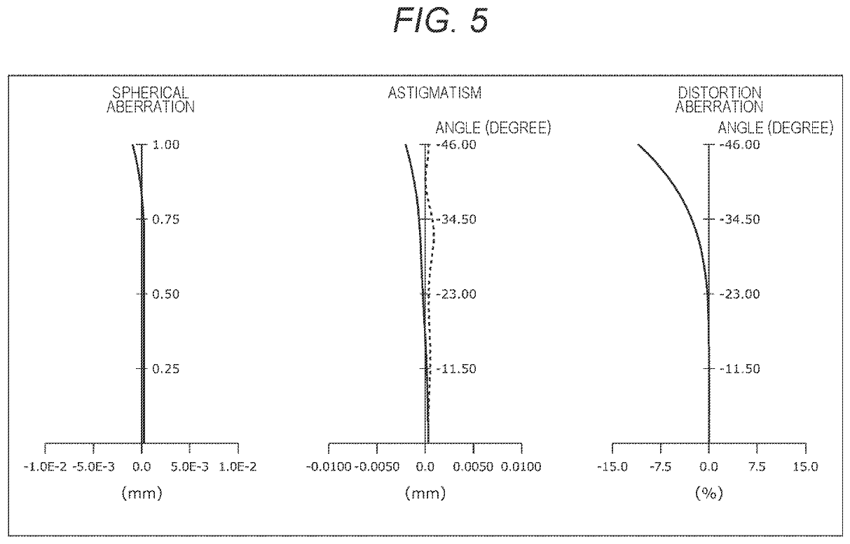

FIG. 5 is a diagram depicting aberration performance of the lens optical system 11-1, and illustrates a spherical aberration diagram, an astigmatism diagram, and a distortion aberration diagram.

Note that, in the spherical aberration diagram, the horizontal axis represents a longitudinal aberration (mm), and the vertical axis represents an image height. The horizontal axis of the astigmatism diagram represents astigmatism (mm), and the vertical axis represents an incident angle (degrees) of the light beam. In the distortion aberration diagram, the horizontal axis represents distortion aberration (%), and the vertical axis represents the incident angle (degree) of the light beam.

As can be seen from each aberration diagram, the lens optical system 11-1 has aberrations corrected well and has excellent image forming performance.

### Second Configuration Example

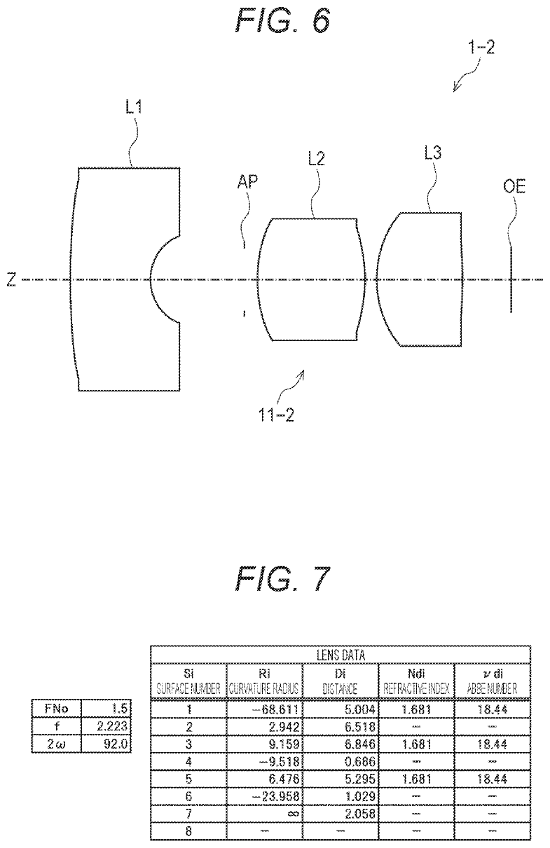

Next, a second configuration example of the optical apparatus to which the present technology is applied will be described with reference to FIGS. 6 to 9.

FIG. 6 is a diagram depicting a configuration example of an optical apparatus 1-2 to which the present technology is applied.

The optical apparatus 1-2 includes an optical element OE and a lens optical system 11-2.

The lens optical system 11-2 is different from the lens optical system 11-1 in FIG. 1 in that a sealing glass SG is not provided. However, it is also possible to add the sealing glass SG.

The lens optical system 11-2 satisfies Conditions 1 and 2 described above. In addition, the lens optical system 11-2 satisfies at least one of Conditions 3 to 9 and preferably satisfies two or more of Conditions 3 to 9.

In a similar manner to FIG. 3, FIG. 7 illustrates specific characteristic data of the lens optical system 11-2 and lens data of the first lens L1 to the third lens L3.

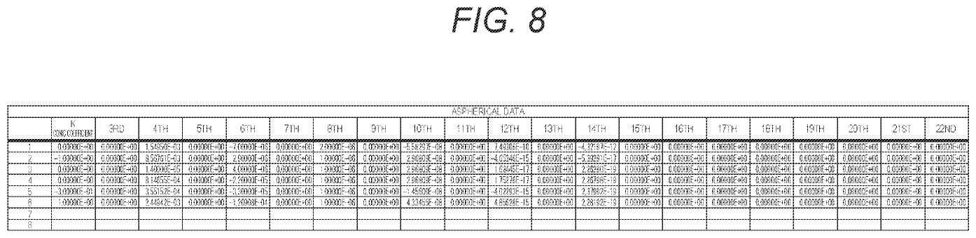

In a similar manner to FIG. 4, FIG. 8 illustrates values of the conic coefficient K of Expression (9) for specifying the aspheric shape of the surface Si of each lens of the lens optical system 11-2 and the aspheric coefficient Ai of the i-th order (i is an integer of three or more).

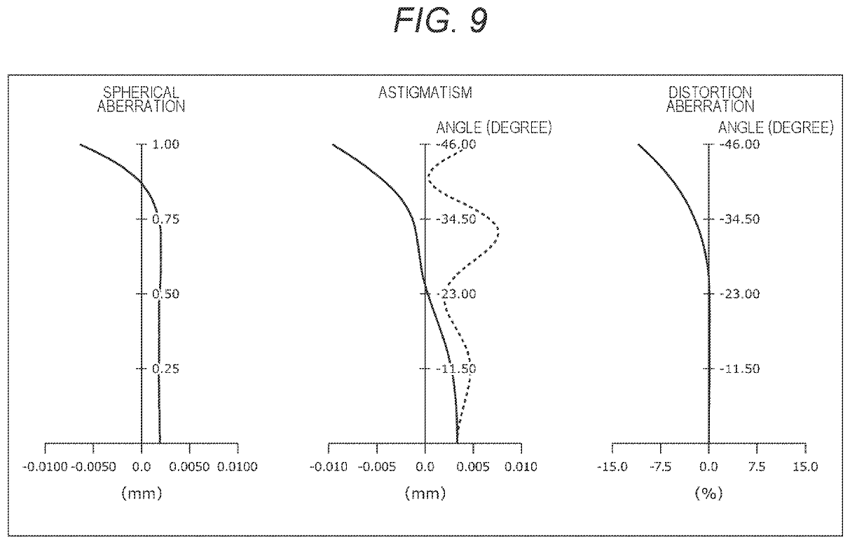

In a similar manner to FIG. 5, FIG. 9 is a diagram depicting aberration performance of the lens optical system 11-2, and illustrates a spherical aberration diagram, an astigmatism diagram, and a distortion aberration diagram.

As can be seen from each aberration diagram, the lens optical system 11-2 has aberrations corrected well and has excellent image forming performance.

### Third Configuration Example

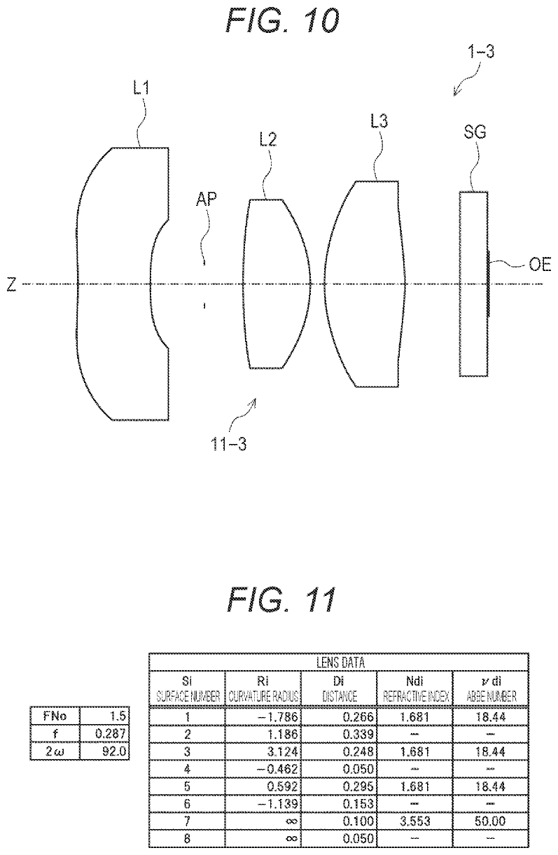

Next, a third configuration example of the optical apparatus to which the present technology is applied will be described with reference to FIGS. 10 to 13.

FIG. 10 is a diagram depicting a configuration example of an optical apparatus 1-3 to which the present technology is applied.

The optical apparatus 1-3 includes an optical element OE and a lens optical system 11-3. The lens optical system 11-3 is different from the lens optical system 11-1 in FIG. 1 in that a sealing glass SG is disposed in contact with a surface of the optical element OE. Note that the sealing glass SG may be omitted.

The lens optical system 11-3 satisfies Conditions 1 and 2 described above. In addition, the lens optical system 11-3 satisfies at least one of Conditions 3 to 9 and preferably satisfies two or more of Conditions 3 to 9.

In a similar manner to FIG. 3, FIG. 11 illustrates specific characteristic data of the lens optical system 11-3 and lens data of the first lens L1 to the third lens L3.

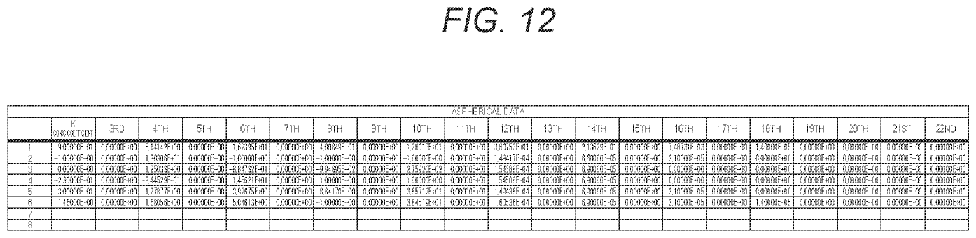

In a similar manner to FIG. 4, FIG. 12 illustrates values of the conic coefficient K of Expression (9) for specifying the aspheric shape of the surface Si of each lens of the lens optical system 11-3 and the aspheric coefficient Ai of the i-th order (i is an integer of three or more).

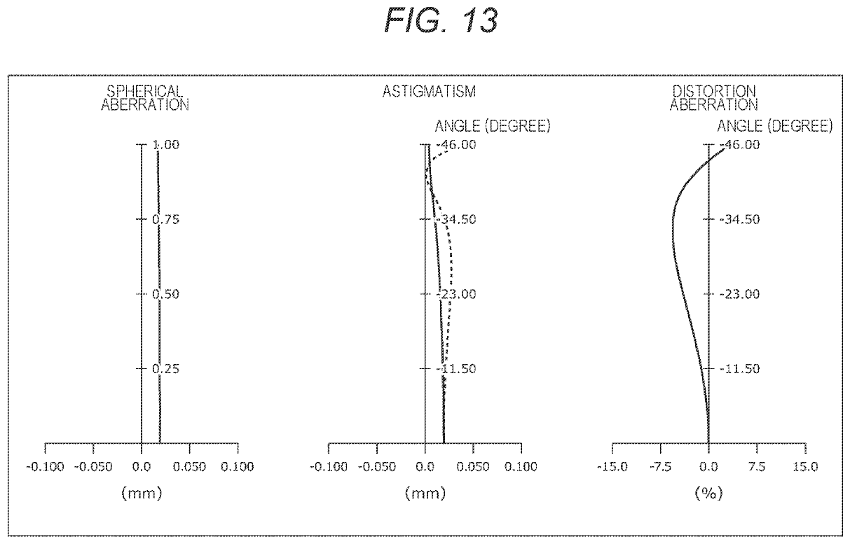

In a similar manner to FIG. 5, FIG. 13 is a diagram depicting aberration performance of the lens optical system 11-3, and illustrates a spherical aberration diagram, an astigmatism diagram, and a distortion aberration diagram.

As can be seen from each aberration diagram, the lens optical system 11-3 has aberrations corrected well and has excellent image forming performance.

### Fourth Configuration Example

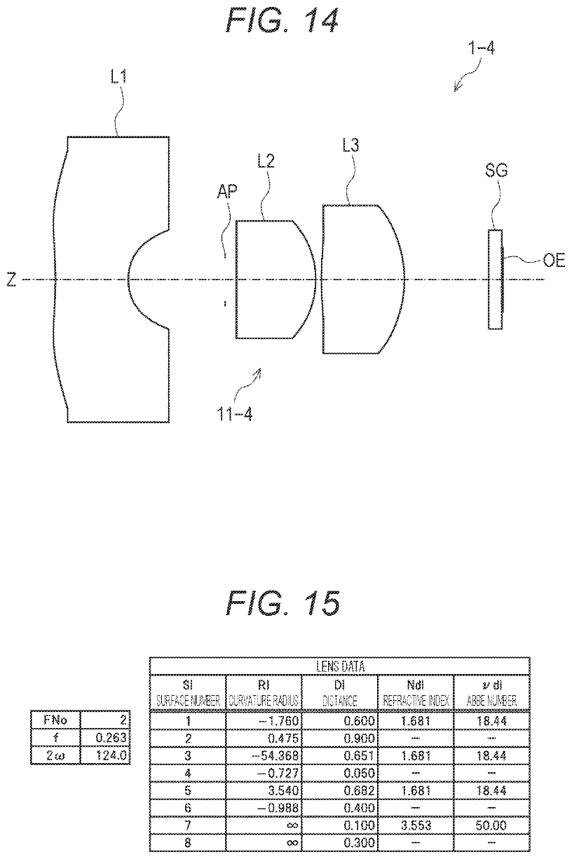

Next, a fourth configuration example of the optical apparatus to which the present technology is applied will be described with reference to FIGS. 14 to 17.

FIG. 14 is a diagram depicting a configuration example of an optical apparatus 1-4 to which the present technology is applied.

The optical apparatus 1-4 includes an optical element OE and a lens optical system 11-4. The lens optical system 11-4 is different from the lens optical system 11-1 in FIG. 1 in that a sealing glass SG is disposed in contact with a surface of the optical element OE. Note that the sealing glass SG may be omitted.

The lens optical system 11-4 satisfies Conditions 1 and 2 described above. In addition, the lens optical system 11-4 satisfies at least one of Conditions 3 to 9 and preferably satisfies two or more of Conditions 3 to 9.

In a similar manner to FIG. 3, FIG. 15 illustrates specific characteristic data of the lens optical system 11-4 and lens data of the first lens L1 to the third lens L3.

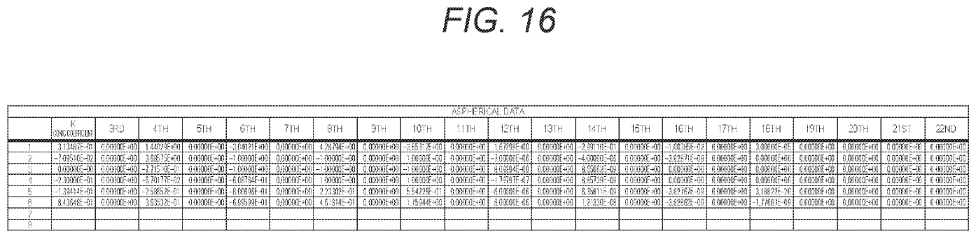

In a similar manner to FIG. 4, FIG. 16 illustrates values of the conic coefficient K of Expression (9) for specifying the aspheric shape of the surface Si of each lens of the lens optical system 11-4 and the aspheric coefficient Ai of the i-th order (i is an integer of three or more).

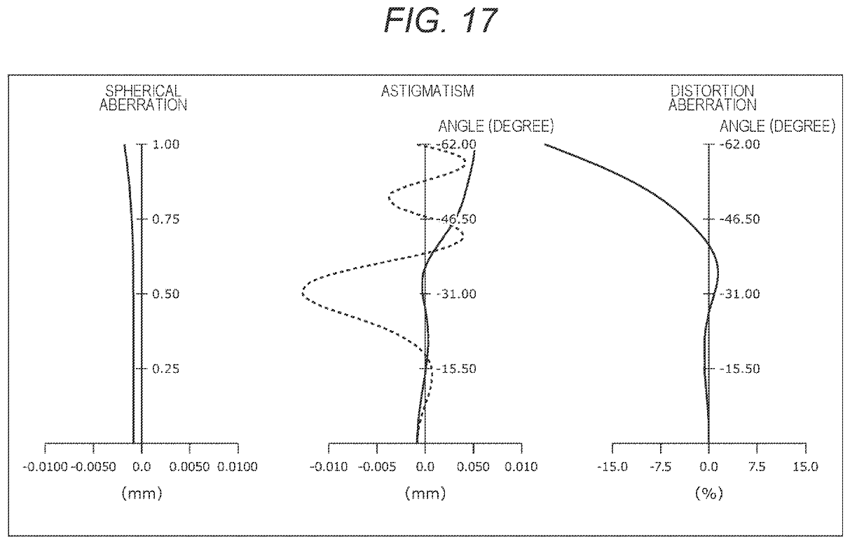

In a similar manner to FIG. 5, FIG. 17 is a diagram depicting aberration performance of the lens optical system 11-4, and illustrates a spherical aberration diagram, an astigmatism diagram, and a distortion aberration diagram.

As can be seen from each aberration diagram, the lens optical system 11-4 has aberrations corrected well and has excellent image forming performance.

### Fifth Configuration Example

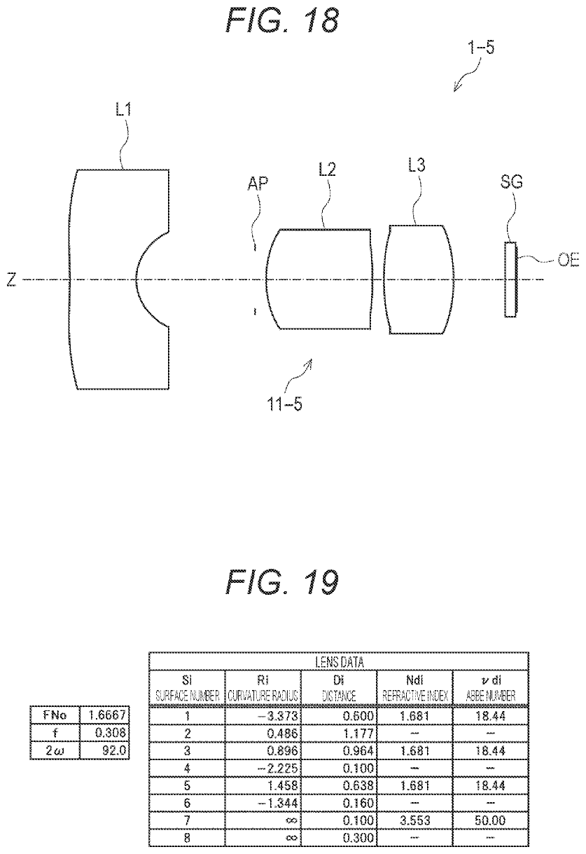

Next, a fifth configuration example of the optical apparatus to which the present technology is applied will be described with reference to FIGS. 18 to 21.

FIG. 18 is a diagram depicting a configuration example of an optical apparatus 1-5 to which the present technology is applied.

The optical apparatus 1-5 includes an optical element OE and a lens optical system 11-5. The lens optical system 11-5 is different from the lens optical system 11-1 in FIG. 1 in that a sealing glass SG is disposed in contact with a surface of the optical element OE. Note that the sealing glass SG may be omitted.

The lens optical system 11-5 satisfies Conditions 1 and 2 described above. In addition, the lens optical system 11-5 satisfies at least one of Conditions 3 to 9 and preferably satisfies two or more of Conditions 3 to 9.

In a similar manner to FIG. 3, FIG. 19 illustrates specific characteristic data of the lens optical system 11-5 and lens data of the first lens L1 to the third lens L3.

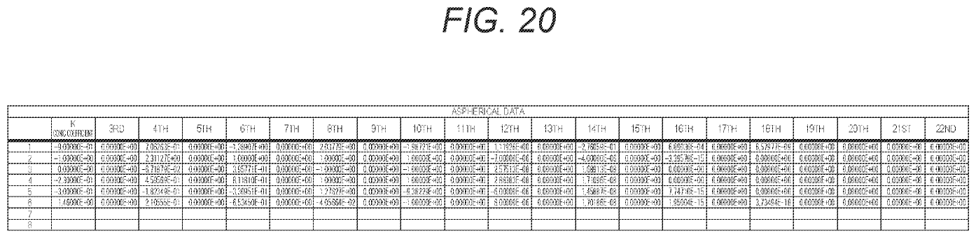

In a similar manner to FIG. 4, FIG. 20 illustrates values of the conic coefficient K of Expression (9) for specifying the aspheric shape of the surface Si of each lens of the lens optical system 11-5 and the aspheric coefficient Ai of the i-th order (i is an integer of three or more).

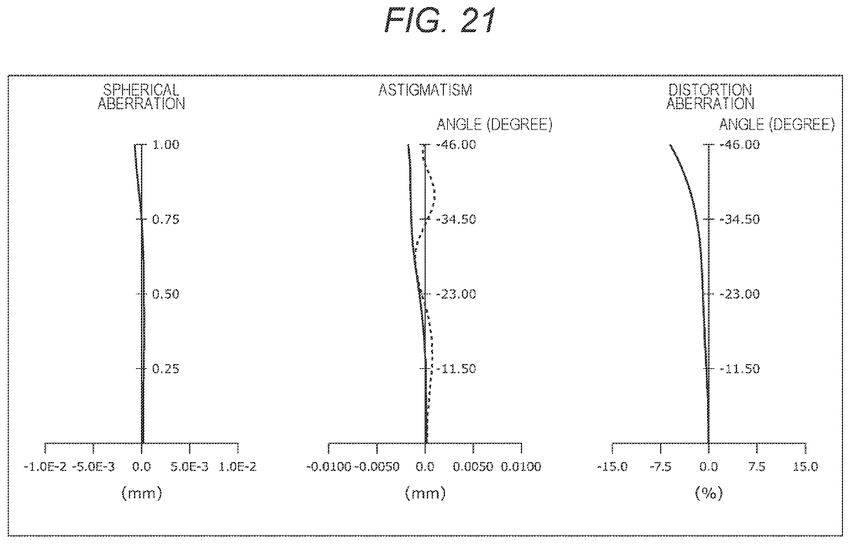

In a similar manner to FIG. 5, FIG. 21 is a diagram depicting aberration performance of the lens optical system 11-5, and illustrates a spherical aberration diagram, an astigmatism diagram, and a distortion aberration diagram.

As can be seen from each aberration diagram, the lens optical system 11-5 has aberrations corrected well and has excellent image forming performance.

### Sixth Configuration Example

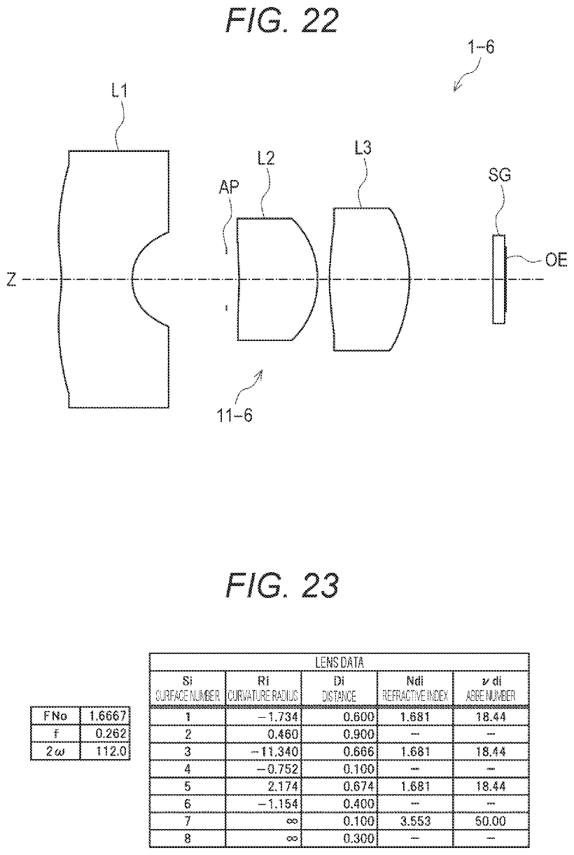

Next, a sixth configuration example of the optical apparatus to which the present technology is applied will be described with reference to FIGS. 22 to 25.

FIG. 22 is a diagram depicting a configuration example of an optical apparatus 1-6 to which the present technology is applied.

The optical apparatus 1-6 includes an optical element OE and a lens optical system 11-6. The lens optical system 11-6 is different from the lens optical system 11-1 in FIG. 1 in that a sealing glass SG is disposed in contact with a surface of the optical element OE. Note that the sealing glass SG may be omitted.

The lens optical system 11-6 satisfies Conditions 1 and 2 described above. In addition, the lens optical system 11-6 satisfies at least one of Conditions 3 to 9 and preferably satisfies two or more of Conditions 3 to 9.

In a similar manner to FIG. 3, FIG. 23 illustrates specific characteristic data of the lens optical system 11-6 and lens data of the first lens L1 to the third lens L3.

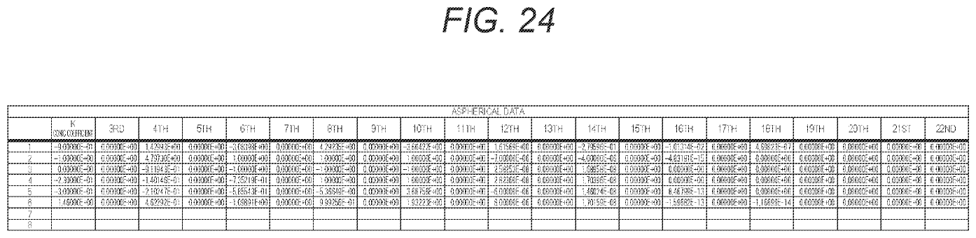

In a similar manner to FIG. 4, FIG. 24 illustrates values of the conic coefficient K of Expression (9) for specifying the aspheric shape of the surface Si of each lens of the lens optical system 11-6 and the aspheric coefficient Ai of the i-th order (i is an integer of three or more).

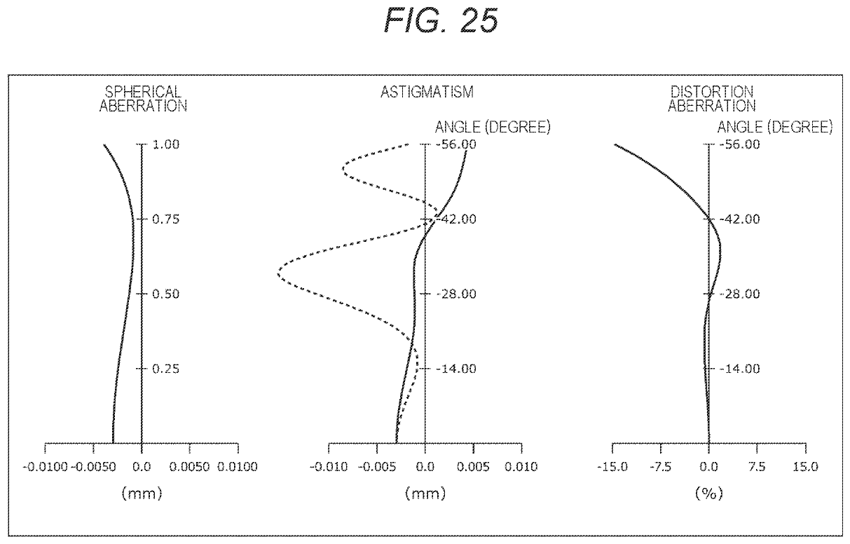

In a similar manner to FIG. 5, FIG. 25 is a diagram depicting aberration performance of the lens optical system 11-6, and illustrates a spherical aberration diagram, an astigmatism diagram, and a distortion aberration diagram.

As can be seen from each aberration diagram, the lens optical system 11-6 has aberrations corrected well and has excellent image forming performance.

### Seventh Configuration Example

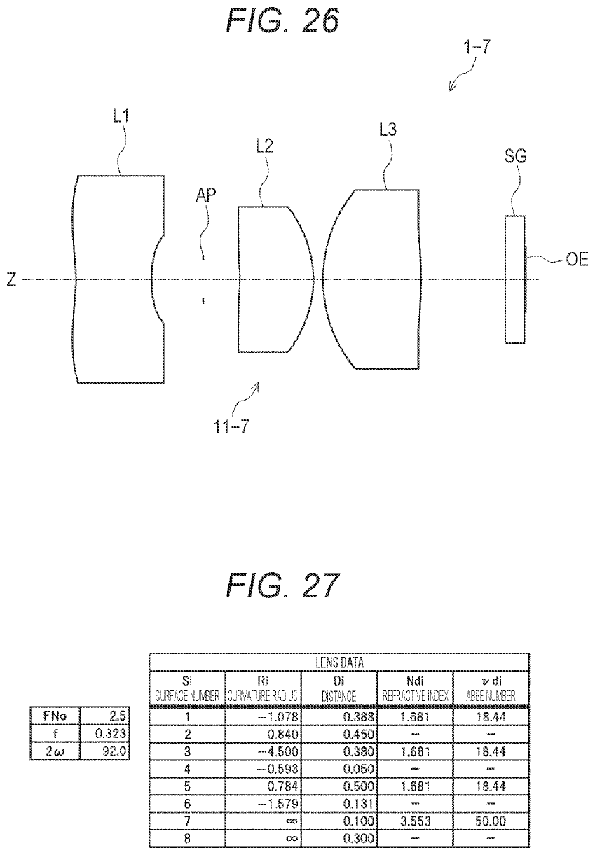

Next, a seventh configuration example of the optical apparatus to which the present technology is applied will be described with reference to FIGS. 26 to 29.

FIG. 26 is a diagram depicting a configuration example of an optical apparatus 1-7 to which the present technology is applied.

The optical apparatus 1-7 includes an optical element OE and a lens optical system 11-7. The lens optical system 11-7 is different from the lens optical system 11-1 in FIG. 1 in that a sealing glass SG is disposed in contact with a surface of the optical element OE. Note that the sealing glass SG may be omitted.

The lens optical system 11-7 satisfies Conditions 1 and 2 described above. In addition, the lens optical system 11-7 satisfies at least one of Conditions 3 to 9 and preferably satisfies two or more of Conditions 3 to 9.

In a similar manner to FIG. 3, FIG. 27 illustrates specific characteristic data of the lens optical system 11-7 and lens data of the first lens L1 to the third lens L3.

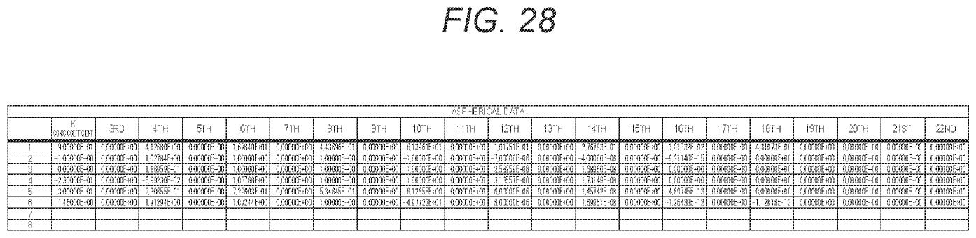

In a similar manner to FIG. 4, FIG. 28 illustrates values of the conic coefficient K of Expression (9) for specifying the aspheric shape of the surface Si of each lens of the lens optical system 11-7 and the aspheric coefficient Ai of the i-th order (i is an integer of three or more).

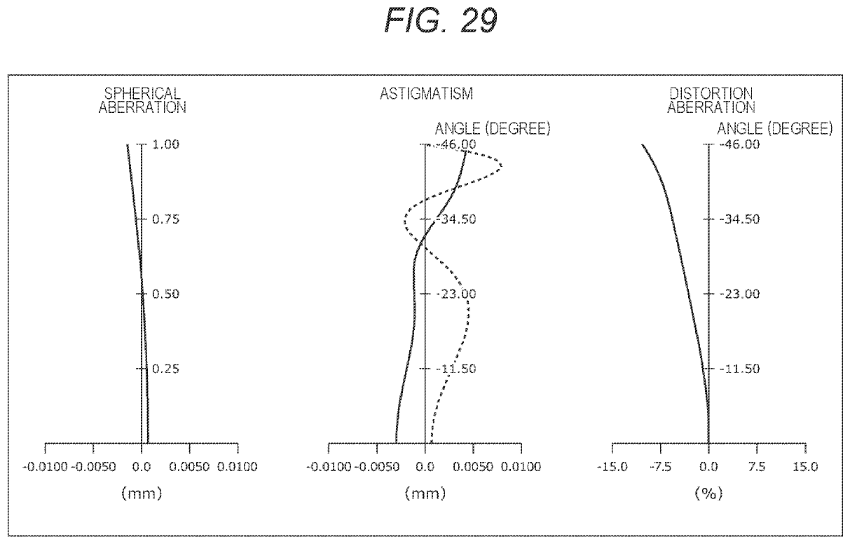

In a similar manner to FIG. 5, FIG. 29 is a diagram depicting aberration performance of the lens optical system 11-7, and illustrates a spherical aberration diagram, an astigmatism diagram, and a distortion aberration diagram.

As can be seen from each aberration diagram, the lens optical system 11-7 has aberrations corrected well and has excellent image forming performance.

### Eighth Configuration Example

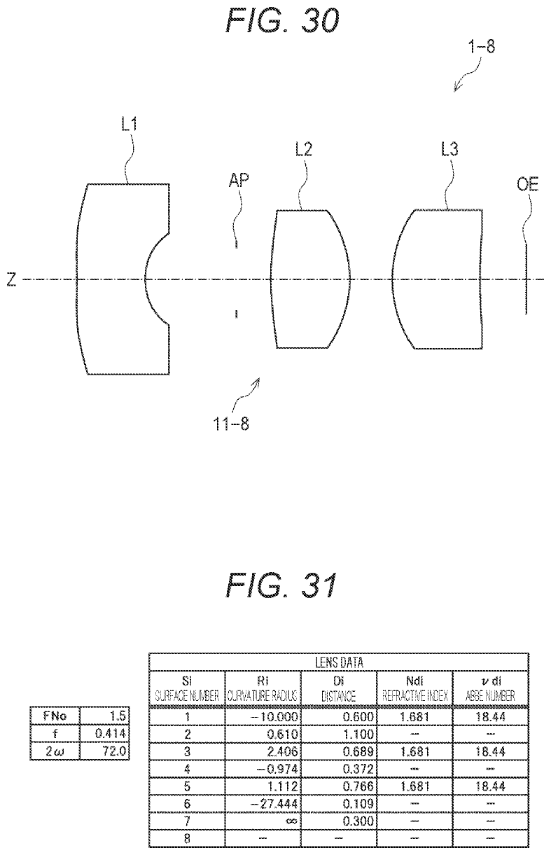

Next, an eighth configuration example of the optical apparatus to which the present technology is applied will be described with reference to FIGS. 30 to 33.

FIG. 30 is a diagram depicting a configuration example of an optical apparatus 1-8 to which the present technology is applied.

The optical apparatus 1-8 includes an optical element OE and a lens optical system 11-8. The lens optical system 11-8 is different from the lens optical system 11-1 in FIG. 1 in that a sealing glass SG is not provided. However, it is also possible to add the sealing glass SG.

The lens optical system 11-8 satisfies Conditions 1 and 2 described above. In addition, the lens optical system 11-8 satisfies at least one of Conditions 3 to 9 and preferably satisfies two or more of Conditions 3 to 9.

In a similar manner to FIG. 3, FIG. 31 illustrates specific characteristic data of the lens optical system 11-8 and lens data of the first lens L1 to the third lens L3.

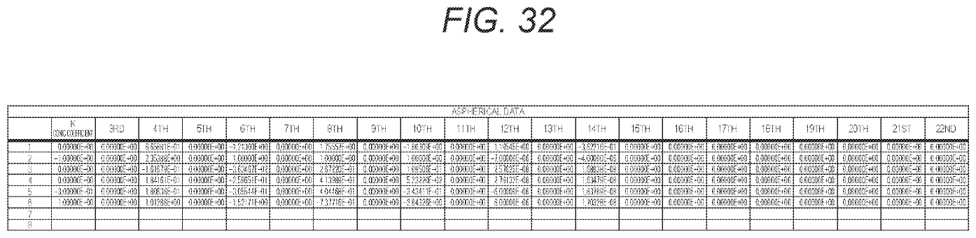

In a similar manner to FIG. 4, FIG. 32 illustrates values of the conic coefficient K of Expression (9) for specifying the aspheric shape of the surface Si of each lens of the lens optical system 11-8 and the aspheric coefficient Ai of the i-th order (i is an integer of three or more).

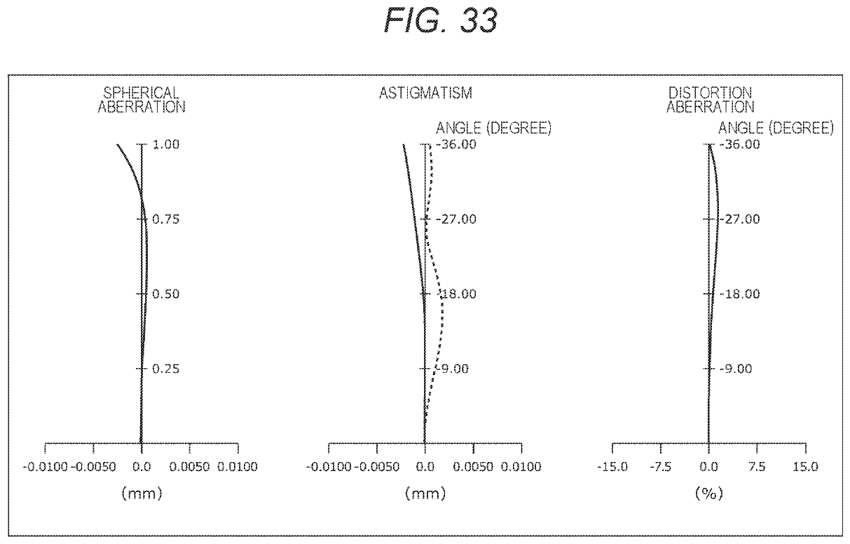

In a similar manner to FIG. 5, FIG. 33 is a diagram depicting aberration performance of the lens optical system 11-8, and illustrates a spherical aberration diagram, an astigmatism diagram, and a distortion aberration diagram.

As can be seen from each aberration diagram, the lens optical system 11-8 has aberrations corrected well and has excellent image forming performance.

### Ninth Configuration Example

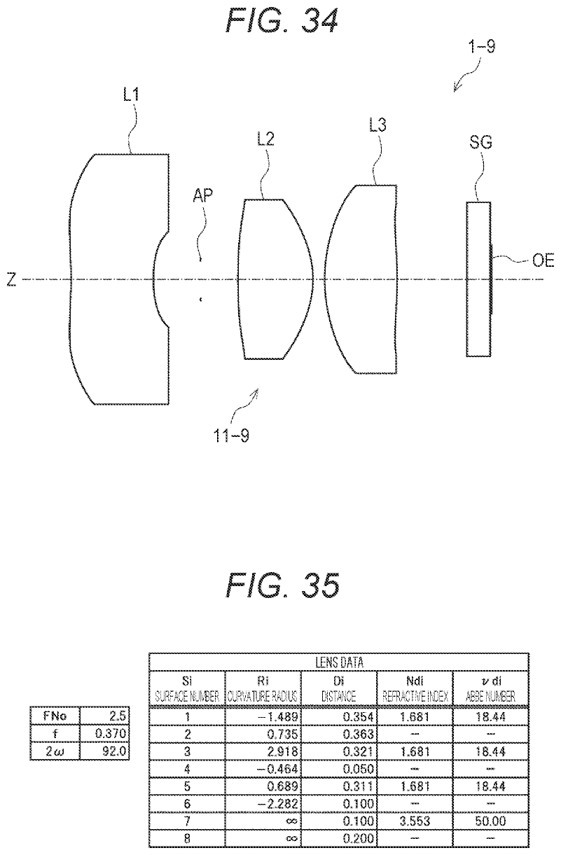

Next, a ninth configuration example of the optical apparatus to which the present technology is applied will be described with reference to FIGS. 34 to 37.

FIG. 34 is a diagram depicting a configuration example of an optical apparatus 1-9 to which the present technology is applied.

The optical apparatus 1-9 includes an optical element OE and a lens optical system 11-9. The lens optical system 11-9 is different from the lens optical system 11-1 in FIG. 1 in that a sealing glass SG is disposed in contact with a surface of the optical element OE. Note that the sealing glass SG may be omitted.

The lens optical system 11-9 satisfies Conditions 1 and 2 described above. In addition, the lens optical system 11-9 satisfies at least one of Conditions 3 to 9 and preferably satisfies two or more of Conditions 3 to 9.

In a similar manner to FIG. 3, FIG. 35 illustrates specific characteristic data of the lens optical system 11-9 and lens data of the first lens L1 to the third lens L3.

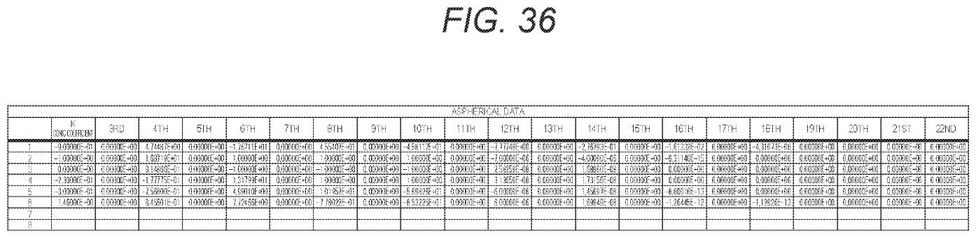

In a similar manner to FIG. 4, FIG. 36 illustrates values of the conic coefficient K of Expression (9) for specifying the aspheric shape of the surface Si of each lens of the lens optical system 11-9 and the aspheric coefficient Ai of the i-th order (i is an integer of three or more).

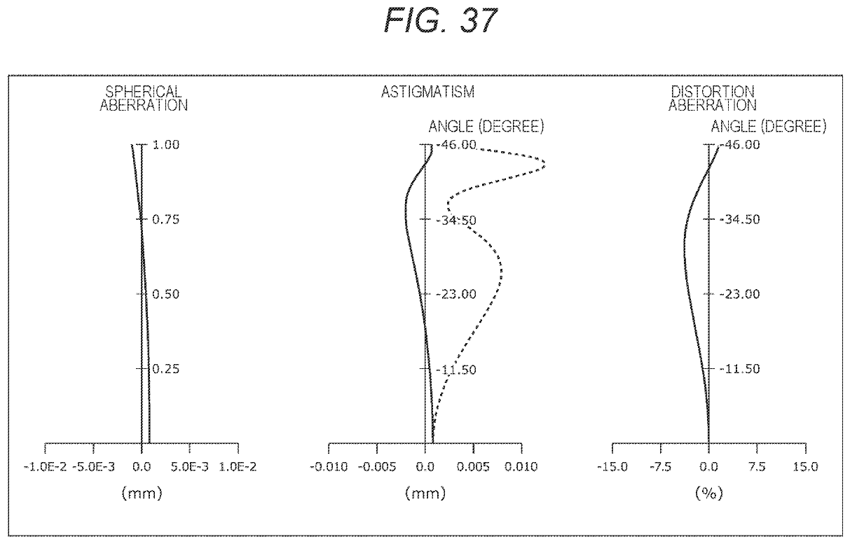

In a similar manner to FIG. 5, FIG. 37 is a diagram depicting aberration performance of the lens optical system 11-9, and illustrates a spherical aberration diagram, an astigmatism diagram, and a distortion aberration diagram.

As can be seen from each aberration diagram, the lens optical system 11-9 has aberrations corrected well and has excellent image forming performance.

### Tenth Configuration Example

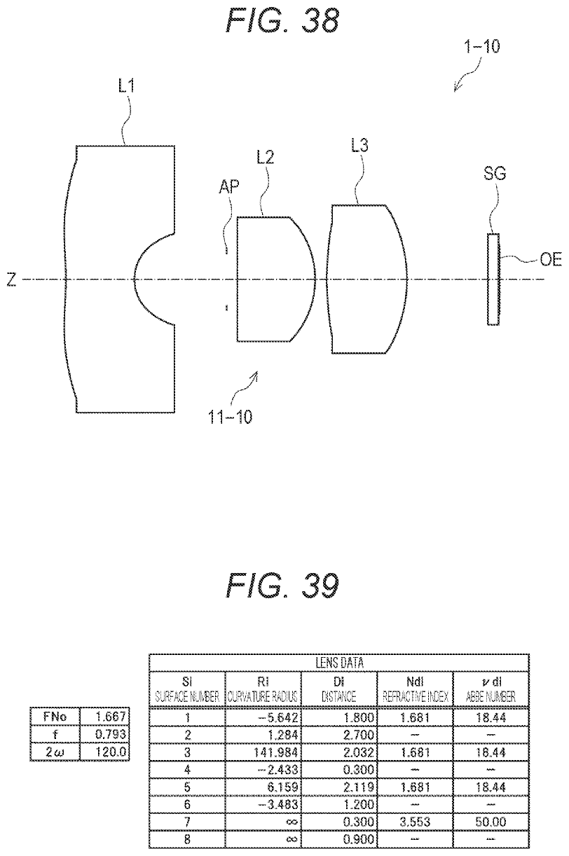

Next, a tenth configuration example of the optical apparatus to which the present technology is applied will be described with reference to FIGS. 38 to 41.

FIG. 38 is a diagram depicting a configuration example of an optical apparatus 1-10 to which the present technology is applied.

The optical apparatus 1-10 includes an optical element OE and a lens optical system 11-10. The lens optical system 11-10 is different from the lens optical system 11-1 in FIG. 1 in that a sealing glass SG is disposed in contact with a surface of the optical element OE. Note that the sealing glass SG may be omitted.

The lens optical system 11-10 satisfies Conditions 1 and 2 described above. In addition, the lens optical system 11-10 satisfies at least one of Conditions 3 to 9 and preferably satisfies two or more of Conditions 3 to 9.

In a similar manner to FIG. 3, FIG. 39 illustrates specific characteristic data of the lens optical system 11-10 and lens data of the first lens L1 to the third lens L3.

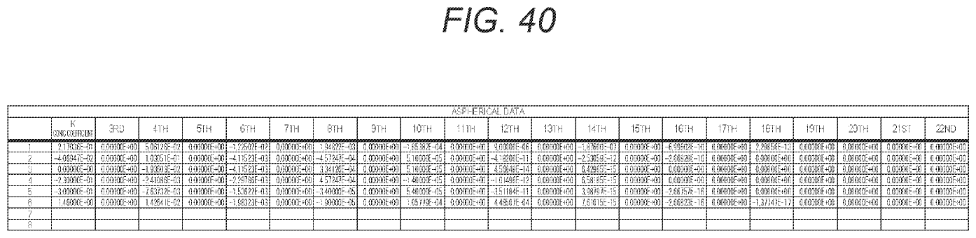

In a similar manner to FIG. 4, FIG. 40 illustrates values of the conic coefficient K of Expression (9) for specifying the aspheric shape of the surface Si of each lens of the lens optical system 11-10 and the aspheric coefficient Ai of the i-th order (i is an integer of three or more).

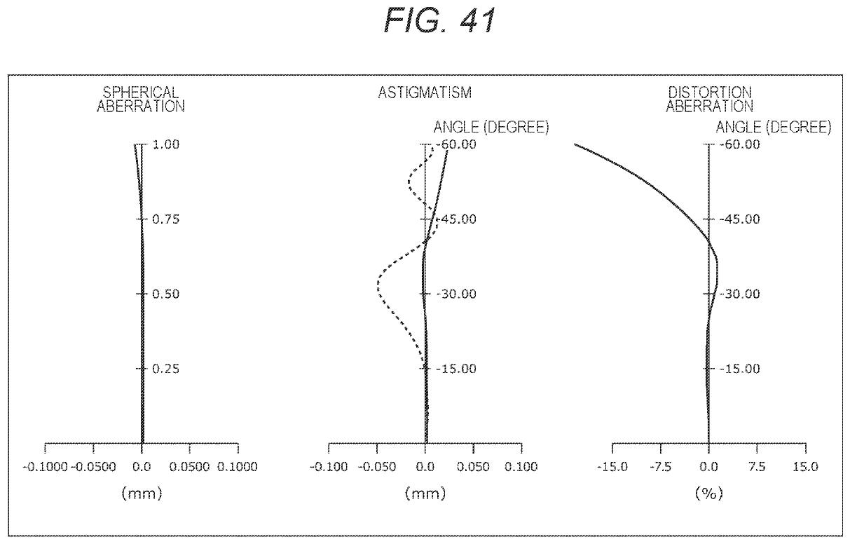

In a similar manner to FIG. 5, FIG. 41 is a diagram depicting aberration performance of the lens optical system 11-10, and illustrates a spherical aberration diagram, an astigmatism diagram, and a distortion aberration diagram.

As can be seen from each aberration diagram, the lens optical system 11-10 has aberrations corrected well and has excellent image forming performance.

### Eleventh Configuration Example

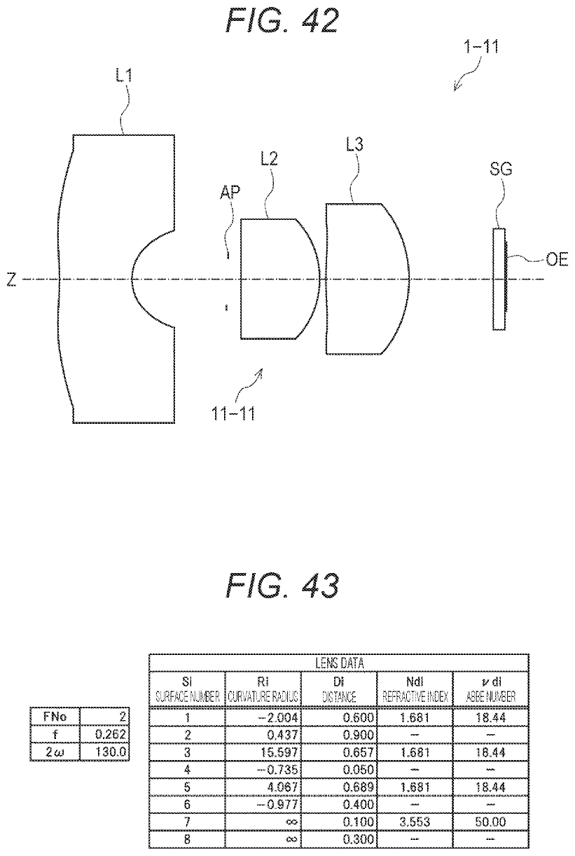

Next, an eleventh configuration example of the optical apparatus to which the present technology is applied will be described with reference to FIGS. 42 to 45.

FIG. 42 is a diagram depicting a configuration example of an optical apparatus 1-11 to which the present technology is applied.

The optical apparatus 1-11 includes an optical element OE and a lens optical system 11-11. The lens optical system 11-11 is different from the lens optical system 11-1 in FIG. 1 in that a sealing glass SG is disposed in contact with a surface of the optical element OE. Note that the sealing glass SG may be omitted.

The lens optical system 11-11 satisfies Conditions 1 and 2 described above. In addition, the lens optical system 11-11 satisfies at least one of Conditions 3 to 9 and preferably satisfies two or more of Conditions 3 to 9.

In a similar manner to FIG. 3, FIG. 43 illustrates specific characteristic data of the lens optical system 11-11 and lens data of the first lens L1 to the third lens L3.

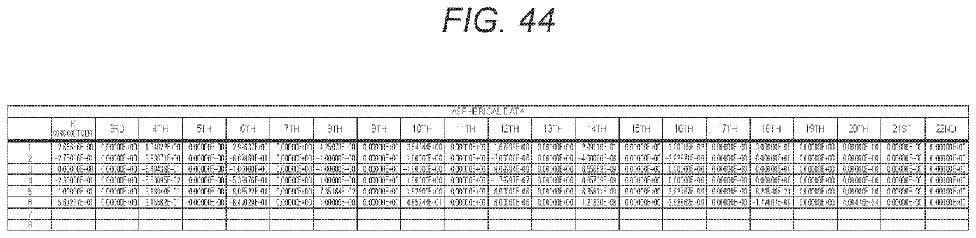

In a similar manner to FIG. 4, FIG. 44 illustrates values of the conic coefficient K of Expression (9) for specifying the aspheric shape of the surface Si of each lens of the lens optical system 11-11 and the aspheric coefficient Ai of the i-th order (i is an integer of three or more).

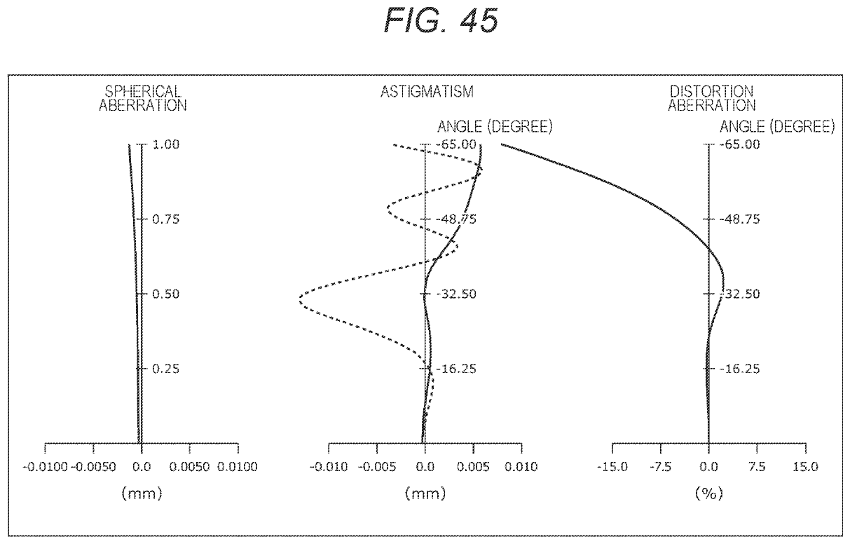

In a similar manner to FIG. 5, FIG. 45 is a diagram depicting aberration performance of the lens optical system 11-11, and illustrates a spherical aberration diagram, an astigmatism diagram, and a distortion aberration diagram.

As can be seen from each aberration diagram, the lens optical system 11-11 has aberrations corrected well and has excellent image forming performance.

Note that, hereinafter, in a case where it is not necessary to individually distinguish the optical apparatuses 1-1 to 1-11, the optical apparatuses 1-1 to 1-11 are simply referred to as the optical apparatus 1. Hereinafter, in a case where it is not necessary to individually distinguish the lens optical systems 11-1 to 11-11, the lens optical systems 11-1 to 11-11 are simply referred to as the lens optical system 11.

### Specific Examples of Parameters of Lens Optical System and Values of Conditional Expressions

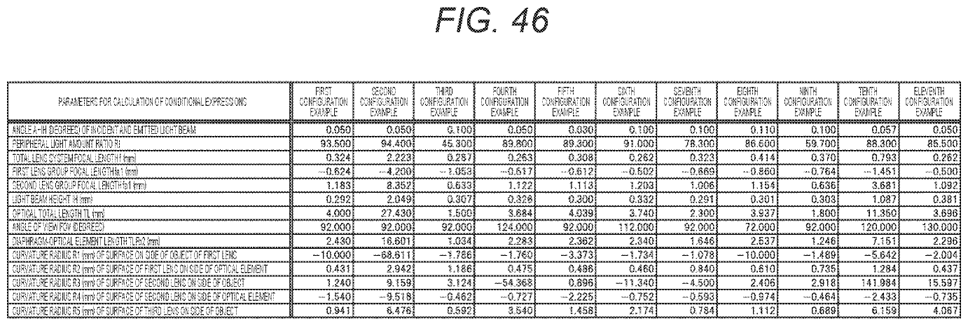

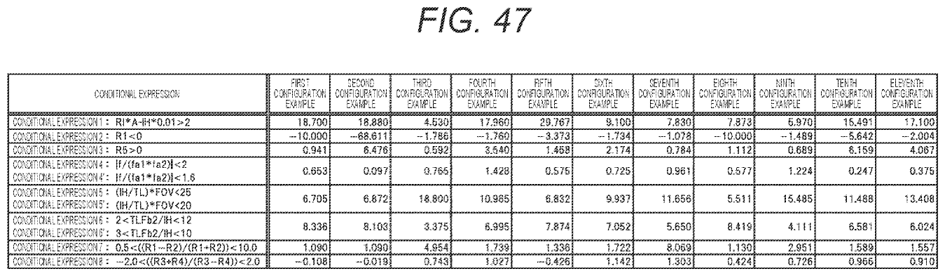

Next, specific examples of parameters of each lens optical system 11 of each optical apparatus 1 described above and the values of the conditional expressions (1) to (8) will be described with reference to FIGS. 46 and 47.

FIG. 46 illustrates specific examples of parameters necessary for calculating the values of the conditional expressions (1) to (8) of each lens optical system 11. Specifically, FIG. 46 illustrates examples of specific values of the angle A−IH (degrees) of an incident and emitted light beam, the peripheral light amount ratio RI, the total lens system focal length f (mm), the first lens group focal length fa1 (mm), the second lens group focal length fa2 (mm), the light beam height IH (mm), the optical total length TL (mm), the angle of view FOV (degrees), and the diaphragm-optical element length TLFb2 (mm). Furthermore, FIG. 46 illustrates examples of specific values of the curvature radius R1 (mm) of the surface S1 on the side of the object of the first lens L1, the curvature radius R2 (mm) of the surface S2 of the first lens L1 on the side of the optical element OE, the curvature radius R3 (mm) of the surface S3 of the second lens L2 on the side of the object, the curvature radius R4 (mm) of the surface S4 of the second lens L2 on the side of the optical element OE, and the curvature radius R5 (mm) of the surface S5 of the third lens L3 on the side of the object.

FIG. 47 illustrates specific examples of values of the conditional expressions (1) to (8) of each lens optical system 11, the values being calculated on the basis of the parameters illustrated in FIG. 46.

As illustrated in these examples, each lens optical system 11 satisfies all the conditional expressions (1) to (8). In addition, each lens optical system 11 also satisfies the conditional expressions (4)′ to (6)′, which are more preferable conditions.

As described above, it is possible to achieve the lens optical systems 11-1 to 11-11 which have good optical performance corresponding to the optical element OE (light receiving element or light emitting element), and are small in size and height and highly efficient with little decrease in contrast due to ghost and flare. As a result, the optical apparatuses 1-1 to 1-11 can be improved in performance and efficiency and reduced in size and height.

### 2. Application Example

The technology of the present disclosure (present technology) can be applied to various products.

For example, the present invention can be applied to a ranging system including a light emitting apparatus and a light receiving apparatus. Specifically, any one of the optical apparatuses 1-1 to 1-11 can be applied to at least one of the light emitting apparatus or the light receiving apparatus of a ranging system.

In addition, the ranging system to which the present technology is applied can be mounted on electronic devices such as a smartphone, a tablet terminal, a mobile phone, a personal computer, a game machine, a television receiver, a wearable terminal, a digital still camera, a digital video camera, and the like, for example.

Furthermore, for example, the technology of the present disclosure may be implemented as a device mounted on any type of mobile body such as an automobile, an electric vehicle, a hybrid electric vehicle, a motorcycle, a bicycle, a personal mobility, an airplane, a drone, a ship, a robot, and the like.

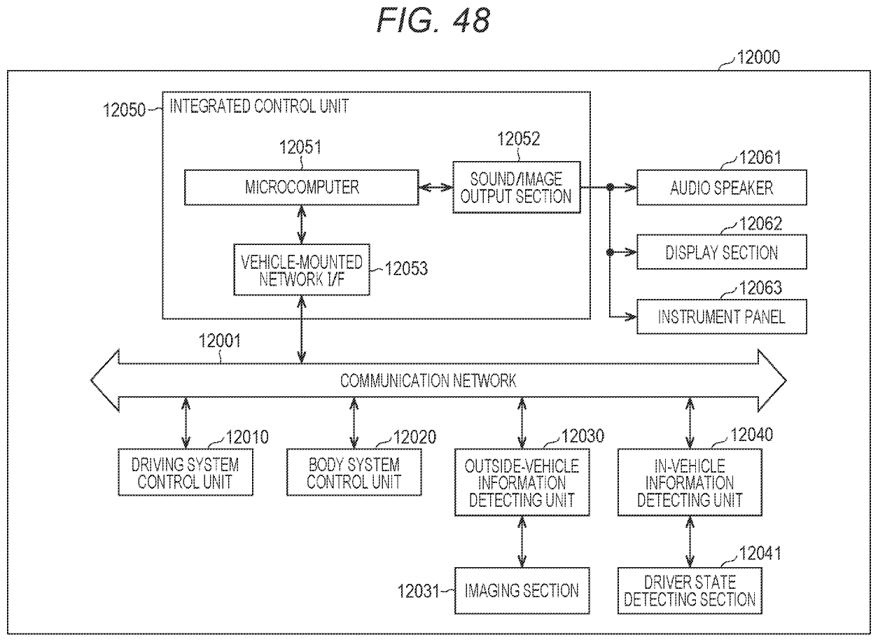

FIG. 48 is a block diagram depicting an example of schematic configuration of a vehicle control system as an example of a mobile body control system to which the technology of the present disclosure can be applied.

The vehicle control system 12000 includes a plurality of electronic control units connected to each other via a communication network 12001. In the example depicted in FIG. 48, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 48, an audio speaker 12061, a display section 12062, and an instrument panel 12063 are illustrated as the output device. The display section 12062 may, for example, include at least one of an on-board display and a head-up display.

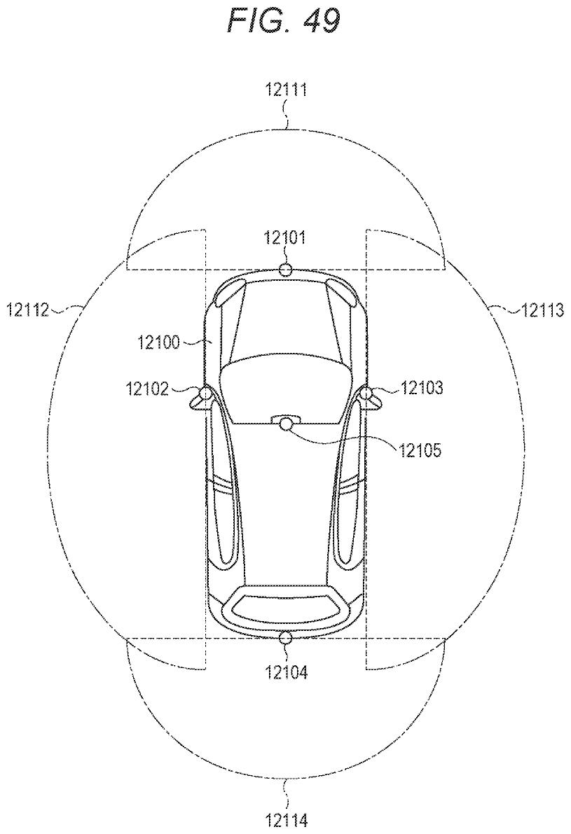

FIG. 49 is a diagram depicting an example of an installation position of the imaging section 12031.

In FIG. 49, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 49 depicts an example of image ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology of the present disclosure can be applied has been described above. The technology of the present disclosure can be applied to the outside-vehicle information detecting unit 12030 and the in-vehicle information detecting unit 12040 among the above-described configurations. Specifically, in the outside-vehicle information detecting unit 12030 and the in-vehicle information detecting unit 12040, processing of recognizing gestures of the driver is performed by using a measured distance by the ranging system using the optical apparatus 1, and various kinds of operations (for example, an audio system, a navigation system, and an air conditioning system) according to the gestures can be executed, or the state of the driver can be detected more accurately. Furthermore, unevenness of a road surface can be recognized by using a measured distance by the ranging system using the optical apparatus 1 and reflected in control of a suspension.

### 3. Others

The embodiment of the present technology is not limited to the above-described embodiment, and various modifications can be made without departing from the gist of the present technology.

A plurality of the present technologies described in the present specification can be implemented independently as a single body as long as there is no contradiction. As a matter of course, a plurality of arbitrary present technologies can be implemented in combination. Furthermore, some or all of the arbitrary present technologies can be implemented in combination with other technologies not described above.

In addition, for example, a configuration described as one device (or processor) may be divided and configured as a plurality of devices (or processors). Conversely, the configurations described above as a plurality of devices (or processors) may be collectively configured as one device (or processor). Further, a configuration other than the above-described configuration may be added to the configuration of each device (or each processor). Furthermore, as long as the configuration and operation of the system as a whole are substantially the same, a part of the configuration of one device (or processor) may be included in the configuration of another device (or another processor).

Moreover, in the present specification, a system means a set of a plurality of components (devices, modules (parts), and the like), and it does not matter whether or not all the components are in the same housing. Therefore, a plurality of devices accommodated in separate housings and connected via a network and one device in which a plurality of modules is accommodated in one housing are both systems.

Note that the effects herein described are merely examples and are not limited, and effects other than those described in the present specification may be provided.

Note that the present technology can have the following configurations.

(1) An optical apparatus includes a lens optical system disposed between an object and an optical element, in which the lens optical system includes, in order from a side of the object, a first lens group having negative refractive power and a second lens group having positive refractive power, the first lens group includes a first lens having negative refractive power, the second lens group includes a second lens having positive refractive power and a third lens having positive refractive power, the lens optical system has positive refractive power as a whole, and in a case where a light beam is incident from the side of the object, when a ratio of a light beam incident on a peripheral edge of the optical element to a light beam passing through a center of a lens system including the first lens to the third lens is RI, and an angle of a principal light beam incident on an outermost peripheral edge of the optical element is A−IH, a following expression is satisfied: RI×A−IH×0.01>2.

(2) In the optical apparatus according to (1), the first lens has a surface on the side of the object, the surface having a curvature radius of less than 0.

(3) In the optical apparatus according to (2), the surface of the first lens on the side of the object has a central portion having a concave shape and a peripheral edge having a convex shape.

(4) In the optical apparatus according to any of (1) to (3), the third lens has a surface on the side of the object, the surface having a curvature radius of greater than or equal to 0.

(5) In the optical apparatus according to any of (1) to (4), in a case where f is a focal length of the lens system as a whole, fa1 is a focal length of the first lens group, and fa2 is a focal length of the second lens group, a following expression is satisfied:

|f/(fa1×fa2)|<2.

(6) In the optical apparatus according to (5), a following expression is further satisfied:

|f/(fa1×fa2)|<1.6.

(7) In the optical apparatus according to any of (1) to (6), in a case where a height in a direction perpendicular to an optical axis of a light beam incident on the optical element is denoted by IH, a length between the surface of the first lens on the side of the object and the optical element is denoted by TL, and an angle of view of the lens optical system is denoted by FOV, a following expression is satisfied: (IH/TL)×FOV<25.

(8) In the optical apparatus according to (7), a following expression is further satisfied: (IH/TL)×FOV<20.

(9) In the optical apparatus according to any of (1) to (8), in a case where a length between a diaphragm of the lens system and the optical element is TLFb2, and a height of a light beam incident on the optical element in a direction perpendicular to an optical axis is IH, a following expression is satisfied: 2<TLFb2/IH<12.

(10) In the optical apparatus according to (9), a following expression is further satisfied: 3<TLFb2/IH<10.

(11) In the optical apparatus according to any of (1) to (10), in a case where a curvature radius of a surface of the first lens on side of the object is R1 and a curvature radius of the first lens on a side of the optical element is R2, a following expression is satisfied: 0.5<(R1−R2)/(R1+R2)<10.0.

(12) In the optical apparatus according to any of (1) to (11), in a case where a curvature radius of a surface of the second lens on the side of the object is R3 and a curvature radius of the second lens on a side of the optical element is R4, a following expression is satisfied: −2.0<(R3+R4)/(R3−R4)<2.0.

(13) The optical apparatus according to any of (1) to (12), further includes the optical element.

(14) In the optical apparatus according to (13), the optical element is a light receiving element, and the lens optical system guides a light beam incident from the side of the object to the optical element.

(15) In the optical apparatus according to (13), the optical element is a light emitting element, and the lens optical system guides a light beam emitted from the optical element to the side of the object.

### REFERENCE SIGNS LIST

1-1 to 1-11 Optical apparatus
11-1 to 11-11 Lens optical system
L1 to L3 First to third lenses
AP Diaphragm
SG Sealing glass
OE Optical element

1. An optical apparatus comprising a lens optical system disposed between an object and an optical element, wherein
the lens optical system includes, in order from a side of the object, a first lens group having negative refractive power and a second lens group having positive refractive power,
the first lens group includes a first lens having negative refractive power,
the second lens group includes a second lens having positive refractive power and a third lens having positive refractive power,
the lens optical system has positive refractive power as a whole, and
in a case where a light beam is incident from the side of the object, when a ratio of a light beam incident on a peripheral edge of the optical element to a light beam passing through a center of a lens system including the first lens to the third lens is RI, and an angle of a principal light beam incident on an outermost peripheral edge of the optical element is A−IH, a following expression is satisfied:
RI×A−IH×0.01>2.

2. The optical apparatus according to claim 1, wherein the first lens has a surface on the side of the object, the surface having a curvature radius of less than 0.

3. The optical apparatus according to claim 2, wherein the surface of the first lens on the side of the object has a central portion having a concave shape and a peripheral edge having a convex shape.

4. The optical apparatus according to claim 1, wherein the third lens has a surface on the side of the object, the surface having a curvature radius of greater than or equal to 0.

5. The optical apparatus according to claim 1, wherein in a case where f is a focal length of the lens system as a whole, fa1 is a focal length of the first lens group, and fa2 is a focal length of the second lens group, a following expression is satisfied:

|f/(fa1×fa2)|<2.

6. The optical apparatus according to claim 5, wherein a following expression is further satisfied:

|f/(fa1×fa2)|<1.6.

7. The optical apparatus according to claim 1, wherein in a case where a height in a direction perpendicular to an optical axis of a light beam incident on the optical element is denoted by IH, a length between the surface of the first lens on the side of the object and the optical element is denoted by TL, and an angle of view of the lens optical system is denoted by FOV, a following expression is satisfied:
(IH/TL)×FOV<25.

8. The optical apparatus according to claim 7, wherein a following expression is further satisfied:
(IH/TL)×FOV<20.

9. The optical apparatus according to claim 1, wherein in a case where a length between a diaphragm of the lens system and the optical element is TLFb2, and a height of a light beam incident on the optical element in a direction perpendicular to an optical axis is IH, a following expression is satisfied:
2<TLFb2/IH<12.

10. The optical apparatus according to claim 9, wherein a following expression is further satisfied:
3<TLFb2/IH<10.

11. The optical apparatus according to claim 1, wherein in a case where a curvature radius of the surface of the first lens on side of the object is R1 and a curvature radius of the first lens on a side of the optical element is R2, a following expression is satisfied:
0.5<(R1−R2)/(R1+R2)<10.0.

12. The optical apparatus according to claim 1, wherein in a case where a curvature radius of a surface of the second lens on the side of the object is R3 and a curvature radius of the second lens on a side of the optical element is R4, a following expression is satisfied:
−2.0<(R3+R4)/(R3−R4)<2.0.

13. The optical apparatus according to claim 1, further comprising the optical element.

14. The optical apparatus according to claim 13, wherein
the optical element is a light receiving element, and
the lens optical system guides a light beam incident from the side of the object to the optical element.

15. The optical apparatus according to claim 13, wherein
the optical element is a light emitting element, and
the lens optical system guides a light beam emitted from the optical element to the side of the object.
